(19) United States
(12) Patent Application Publication
(10) Pub. No.: US 2023/0348672 A1
(43) Pub. Date: Nov. 2, 2023

(54) METHOD FOR PRODUCING ORGANYLOXYSILANE-TERMINATED POLYMERS

(71) Applicant: Wacker Chemie AG, Munich (DE)

(72) Inventors: Volker STANJEK, Ampfing (DE); Lars ZANDER, Altötting (DE)

(73) Assignee: Wacker Chemie AG, Munich (DE)

(21) Appl. No.: 17/780,548

(22) PCT Filed: Dec. 16, 2019
(86) PCT No.: PCT/EP2019/085383

§ 371 Date: May 27, 2022

(51) Int. Cl. C08G 65/336; C08G 65/08; C08K 5/5475

(52) U.S. Cl. CPC C08G 65/336; C08G 65/08; C08K 5/5475; C08G 2150/00; C08G 2170/00; C08G 2190/00; C08G 2650/04

(57) ABSTRACT

The invention provides a process for preparing a mixture (M) which comprises silane-terminated polymers (SP1) of the general formula (I)

Y¹—[O—C(═O)—NH—(CR¹₂)_{b}—SiRₐ(OR²)₃₋ₐ]ₓ (I),

optionally silane-terminated polymers (SP2) of the general formula (II)

Y²—[O—C(═O)—NH—(CR¹₂)_{b}—SiRₐ(OR²)₃₋ₐ]_{z} (II)
and hydroxy-functional polymers (SP3) of the general formula (III)

Y²—[O—C(═O)—NH—(CR¹₂)_{b}—SiRₐ(OR²)₃₋ₐ]_{z-z1}(OH)_{z1} (III)
where Y¹ and Y² are polymer radicals and R, R¹, R², x, z, z1, a and b have the definitions indicated in claim 1, wherein, in a first process step, at least one polymer (HP1) of the general formula (IV)

Y¹—[OH]ₓ (IV)
reacts with at least one isocyanate-functional silane (S) of the general formula (V)

O═C═N—(CR¹₂)_{b}—SiRₐ(OR²)₃₋ₐ (V)
to give silane-terminated polymers (SP1),
and, in a second process step, the unreacted isocyanate groups of the isocyanate-functional silane (S) of the general formula (V) are reacted with at least one oligomer or polymer (HP2) of the general formula (VI)

Y²(OH)_{z} (VI);
polymer mixtures (M) preparable by the process; and use of the polymer mixtures (M) for producing adhesives and sealants and also coatings.

The invention relates to a process for preparing a mixture comprising organyloxysilane-terminated polymers, to the mixture, and to the use thereof for producing adhesives and sealants.

Polymer systems which possess reactive alkoxysilyl groups, more particularly silane-terminated polyethers, are long-established systems. On contact with water or atmospheric moisture, these alkoxysilane-terminated polymers are capable even at room temperature of undergoing condensation with one another, with elimination of the alkoxy groups. One of the most important applications of such materials is the production of adhesives, more particularly of elastic adhesive systems.

In the production of commercially available products, a variety of processes are known for preparing silane-terminated polymers. One of the most important entails reacting long-chain polyethers with isocyanatoalkyl-functional alkoxysilanes. The latter react with the terminal hydroxyl groups of the polyether, thus permitting virtually complete chain termination with reactive silane functions. This poses a significant advantage over other synthesis routes to the preparation of silane-terminated polymers.

A problem with this process, however, is the fact that the isocyanatoalkyl-functional alkoxysilanes required in this case are highly toxic, it being necessary, consequently, to ensure that they are no longer present in the end product, i.e. in the silane-terminated polymer. At the same time, it is vital for complete and rapid silane termination of all chain ends that these same toxic isocyanatosilanes are used in a certain excess. Without this excess, the reaction rate would drop off sharply towards the end of the reaction, owing to the increasing dilution of the reactive groups. In that way, there would be little or no possibility of sufficiently rapid and therefore economically rational production.

This applies both to batchwise and to continuous production. Long reaction times imply long plant occupancy times and are therefore expensive. For continuous reactions, however, a high reaction rate is even more critical, since in that case the throughput achievable with a plant is directly proportional to the reaction rate, whereas with a batchwise reaction regime there are additional times for charging and discharging, cooling and heating events that are independent of the reaction rate. The effect of the reaction rate on plant throughput is therefore present here as well, but is at least partly “softened”.

For solving this problem, WO2006136261A proposes preparing the silane-terminated polymers in a continuous process using an isocyanatosilane excess.

The unreacted isocyanatosilane residues remaining in the product in that case are scavenged subsequently in a downstream step with an isocyanate-reactive compound, such as an alcohol or an amine. The scavenging reactant specifically described as being used is methanol.

A disadvantage with this process, however, is that in this way a significant proportion of the isocyanatosilane used is no longer employed for the silane termination of polymers, instead reacting ultimately with methanol to form a carbamatosilane by-product. This carbamatosilane may of course take on certain tasks, possibly acting as a water scavenger, for example. However, these tasks can in general also be taken on by far simpler and hence also cheaper silanes such as simple vinyltrimethoxysilane, for example.

Because isocyanatosilanes can only be produced in a very complicated and therefore expensive process, as described in WO2008068175A, for example, this technique proposed in WO2006136261A for destroying the isocyanatosilane excess used in the synthesis of silane-terminated polymers represents an expensive and therefore fairly economically unrational wastage.

From the point of view of a producer of silane-crosslinking polymers, therefore, it would be desirable in any case to be able to provide a process which can be carried out as quickly and easily as that in V2006136261A but without involving the wastage of expensive isocyanatosilanes as described therein.

The invention provides a process for preparing a mixture (M) which comprises silane-terminated polymers (SP1) of the general formula (I)

Y¹—[O—C(═O)—NH—(CR¹₂)_{b}—SiRₐ(OR²)₃₋ₐ]ₓ (I),
optionally silane-terminated polymers (SP2) of the general formula (II)

Y²—[O—C(═O)—NH—(CR¹₂)_{b}—SiRₐ(OR²)₃₋ₐ]_{z} (II)
and hydroxy-functional polymers (SP3) of the general formula (III)

Y²—[O—C(═O)—NH—(CR¹₂)_{b}—SiRₐ(OR²)₃₋ₐ]_{z-z1}(OH)_{z1} (III)
where
Y¹ is an x-valent polymer radical having a numerical average molar mass Mₙ of at least 2000 g/mol,
Y² is a z-valent oligomer or polymer radical having at least 3 identical repeating units which contain at least 2 carbon atoms and at least 1 heteroatom,
R may be identical or different and is a monovalent, optionally substituted hydrocarbon radical,
R¹ may be identical or different and is hydrogen atom or a monovalent, optionally substituted hydrocarbon radical,
R² may be identical or different and is hydrogen atom or a monovalent, optionally substituted hydrocarbon radical,
x is an integer from 2 to 50,
z is an integer from 1 to 50,
z1 is less than or equal to z and is an integer from 1 to 50,
a may be identical or different and is 0, 1 or 2, and
b may be identical or different and is an integer from 1 to 10,
wherein, in a first process step, at least one polymer (HP1) of the general formula (IV)

Y¹—[OH]ₓ (IV)
reacts with at least one isocyanate-functional silane (S) of the general formula (V)

O═C═N—(CR¹₂)_{b}—SiRₐ(OR²)₃₋ₐ (V)
to give silane-terminated polymers (SP1),
where the isocyanate-functional silane (S) of the general formula (V) is used in an amount such that there are at least 1.1 of the isocyanate groups isocyanate-functional silane (S) of the general formula (V) to each hydroxyl group in the compounds (HP1) of the general formula (IV),
and subsequently, in a second process step, all unreacted isocyanate groups of the isocyanate-functional silane (S) of the general formula (V) are reacted with at least one oligomer or polymer (HP2) of the general formula (VI)

Y²(OH)_{z} (VI),
and the compound (HP2) of the general formula (VI) is used in an amount such that there are at least 1.1 hydroxyl groups in the compounds (HP2) of the general formula (IV) to each isocyanate group still present in the reaction mixture after the first process step,
with the proviso that
   either z and z1 in the general formulae (II), (III) and (VI) possess a value of 1, there are silane-terminated polymers (SP2) of the general formula (II) in the mixture (M), and the polymers (SP3) likewise present in the mixture (M) correspond to the polymers (HP2) used in the second reaction step,
   or z in the general formulae (II), (III) and (VI) possesses a value of more than 1, Y² is a z-valent oligomer or polymer radical having a numerical average molar mass Mn of at most 1500 g/mol, and the mixture (M) comprises hydroxy-functional polymers (SP3) in which z1 is less than z.

The isocyanate-functional silane (S) of the general formula (V) is preferably used in an amount such that there are at least 1.15 isocyanate groups to each hydroxyl group in the polymers (HP1) of the general formula (IV) in the first process step.

The oligomer or polymer (HP2) of the general formula (VI) is preferably used in the second process step in an amount such that there are at least 1.2, more preferably at least 1.3, hydroxyl groups to each isocyanate group of the isocyanate-functional silanes (S) of the general formula (V) that has remained in the mixture after the first process step.

If z possesses a value of at least 2, Y² is preferably a z-valent oligomer or polymer radical having a numerical average molar mass Mₙ of at most 1000 g/mol, more preferably of at most 500 g/mol.

In that case as well, the silane-terminated polymer (SP2) is preferably present in the mixture (M) when z possesses a value of at least 2.

In the context of the present invention this number-average molar mass Mₙ is determined preferably via Size Exclusion Chromatography (SEC) against polystyrene standard, in THF, at 60° C., flow rate 1.2 ml/min and detection with RI (refractive index detector) on a Styragel HR3-HR4-HR5-HR5 column set from Waters Corp. USA with an injection volume of 100 μl.

The process of the invention allows the reaction for preparing the polymers (SP1) to be coupled with the preparation of the polymers (SP2) and/or (SP3), this coupling leading to a quick preparation of these polymers in combination with a significant saving in terms of expensive isocyanate-functional silane (S). This is accomplished by first preparing the polymer (SP1) with an excess of isocyanate-functional silanes (S), this silane excess resulting in a high reaction rate. Then, however, this excess of the expensive isocyanate-functional silane (S) is not simply destroyed by addition of methanol, as described in the prior art, but is instead used for preparing the polymers (SP2) and/or (SP3). Since in this second reaction step it is not the isocyanate groups but rather the hydroxyl groups which are present in excess, this second reaction step also proceeds at a high rate, and the resulting product is free from toxicologically critical isocyanate-functional silanes (S).

Inevitably, however, this operation leads to a polymer mixture (M) in which only the polymer (SP1) is largely completely silane-terminated, whereas in addition to the silane-terminated polymers (SP2) there must always be polymers (SP3) present as well which have the same backbone as the polymer (SP2) but are not completely silane-terminated or even not at all silane-terminated and which have a corresponding amount of unreacted hydroxyl functions.

The surprising discovery underlying this invention, therefore, is that such mixtures (M), in spite of the presence of incompletely silane-terminated or totally non-silane-terminated polymers (SP3), have decidedly interesting properties, if
the polymers (SP2) and (SP3) are monofunctional, i.e. possess only one silane or hydroxyl function, respectively (z=z1=1),
or the polymers (SP2) possess more than one silane function and at the same time the polymers (SP2) and (SP3) have polymer backbones with low average molar masses Mn of at most 2000 g/mol, preferably of at most 1000 g/mol, more preferably of at most 500 g/mol.

In the first case, besides the largely fully terminated polymers (SP1), the mixture (M) also comprises polymers (SP2) having only one silane function. Such mixtures exhibit significantly improved adhesion properties. Moreover, they can also be used for producing sealants having a particularly low modulus. Incomplete termination of the in this case monohydroxy-functional polymers (HP2), which in the mixture (M) results in the existence simultaneously of polymers (SP3) without a silane function and those with precisely only hydroxyl function, is surprisingly not a disrupting factor in this case.

In the second case, the polymers (SP2), on the basis of their at least 2 silane functions and low average molar mass, act as additional crosslinkers, resulting in higher hardnesses in the fully cured materials obtainable from the mixture (M).

Incomplete termination of the hydroxy-functional polymers (HP2), resulting in the existence simultaneously of polymers (SP3), is surprisingly not a disrupting factor in this case.

The process of the invention can be carried out batchwise, by first mixing and reacting the hydroxy-functional polymers (HP1) and isocyanate-functional silanes (S) in a suitable reactor, before adding the hydroxy-functional polymers (HP2) and reacting them with the excess of the silanes (S) that has remained after the first reaction step.

The process of the invention, likewise, may also be carried out batchwise by first mixing the above-stated components (HP1) and (S) in a continuous mixer and then passing the mixture continuously through a reactor in which these components can react, before subsequently, in a second mixer, metering the above-stated components (HP2) in continuously. The reaction mixture then subsequently either be passed through a second reactor, or pumped directly into a suitable storage vessel or suitable storage tank, where the second process step of the invention can then take place.
Preferably x is 2 or 3, more preferably 2.
Preferably z is 1, 2 or 3, more preferably 1 or 2.
Preferably z1 is 1, 2 or 3, more preferably 1 or 2.
Preferably a is 0 or 1.
Preferably b is 1, 3 or 4, more preferably 1 or 3, more particularly 1.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals, such as the n-hexyl radical; heptyl radicals, such as the n-heptyl radical; octyl radicals, such as the n-octyl radical, isooctyl radicals and the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl radical and methylcyclohexyl radicals; alkenyl radicals, such as the vinyl, 1-propenyl and the 2-propenyl radical; aryl radicals, such as the phenyl, naphthyl, anthryl and phenanthryl radical; alkaryl radicals, such as o-, m-, p-tolyl radicals; xylyl radicals and ethylphenyl radicals; and aralkyl radicals, such as the benzyl radical, the α- and the β-phenylethyl radical.

Examples of substituted radicals R are haloalkyl radicals, such as the 3,3,3-trifluoro-n-propyl radical, the 2,2,2,2′,2′,2′-hexafluoroisopropyl radical and the heptafluoroisopropyl radical, and haloaryl radicals, such as the o-, m- and p-chlorophenyl radical.

Radical R preferably comprises monovalent hydrocarbon radicals having 1 to 6 carbon atoms and optionally substituted by halogen atoms. Unsubstituted hydrocarbon radicals are preferred. Radical R in particular is an alkyl radical having 1 or 2 carbon atoms, more particularly methyl radical.

Examples of radicals R¹ are hydrogen atom or the radicals indicated for R.

Radical R¹ preferably comprises hydrogen atom or hydrocarbon radicals having 1 to 20 carbon atoms, more particularly hydrogen atom.

Examples of radical R² are hydrogen atom or the examples indicated for radical R.

Radical R² preferably comprises hydrogen atom or alkyl radicals having 1 to 10 carbon atoms and optionally substituted by halogen atoms, more preferably alkyl radicals having 1 to 4 carbon atoms, more particularly the methyl or ethyl radical.

The radicals Y¹ preferably have number-average molar masses Mₙ of at least 8 000 g/mol, more preferably of at least 10 000 g/mol. The radicals Y¹ preferably have number-average molar masses Mₙ of at most 40 000 g/mol, more particularly of at most 25 000 g/mol, more particularly of at most 20 000 g/mol.

Examples of polymer radical Y¹ are organic polymer radicals, preferably whose number-average molecular mass is 200 to 40 000 g/mol and which comprise as their polymer chain polyoxyalkylenes, such as polyoxyethylene, polyoxypropylene, polyoxybutylene, polyoxytetramethylene, polyoxyethylene-polyoxypropylene copolymer and polyoxypropylene-polyoxybutylene copolymer; hydrocarbon polymers, such as polyisobutylene and copolymers of polyisobutylene with isoprene; polychloroprenes; polyisoprenes; polyurethanes; polyesters; polyamides; polyacrylates; polymetacrylates; vinyl polymer or polycarbonates.

The polymer radical Y¹ preferably comprises polyester, polyether, polyurethane, polyalkylene or polyacrylate radicals, more preferably polyurethane radicals, polyester radicals or polyoxyalkylene radicals, more particularly polyoxypropylene radicals.

Where z and z1 in the formulae (II), (III) and (VI) possess a value of 1, the radicals Y² preferably have number-average molar masses Mₙ of at least 150 g/mol, more preferably of at least 200 g/mol, and preferably number-average molar masses Mₙ of at most 20 000 g/mol, more particularly of at most 10 000 g/mol.

Where z and z1 in the general formulae (II), (III) and (VI) possess a value greater than 1, the radicals Y² preferably have number-average molar masses Mₙ of at least 150 g/mol, more preferably of at least 200 g/mol, and preferably number-average molar masses Mₙ of at most 1 000 g/mol, more particularly of at most 500 g/mol.

The heteroatoms in the polymer radical in Y² are preferably selected from nitrogen, phosphorus, oxygen and sulfur.

Examples of a corresponding polymer radical Y² are organic polymer radicals having the above-indicated number-average molecular masses Mₙ, which as their polymer chain comprise polyoxyalkylenes, such as polyoxyethylene, polyoxypropylene, polyoxybutylene, polyoxytetramethylene, polyoxyethylene-polyoxypropylene copolymer and polyoxypropylene-polyoxybutylene copolymer; hydrocarbon polymers, such as polyisobutylene and copolymers of polyisobutylene with isoprene; polychloroprenes; polyisoprenes; polyurethanes; polyesters; polyamides; polyacrylates; polymetacrylates; vinyl polymer or polycarbonates.

The polymer radical Y² preferably comprises polyester, polyether, polyurethane, polyalkylene or polyacrylate radicals, more preferably polyurethane radicals, polyester radicals or polyoxyalkylene radicals, more particularly polyoxypropylene radicals.

The structure of the polymers (HP1) of the general formula (IV) that are to be used is evident from the above-described possible and also preferred definitions of the radicals Y¹. The polymers (HP1) to be used are preferably polyurethanes or polyethers having a viscosity of 500 to 1 000 000 mPas, more preferably of 1000 to 300 000 mPas. With particular preference they are polypropylene glycols having a viscosity of 1 000 to 40 000 mPas.

The structure of the polymers (HP2) of the general formula (VI) that are to be used is evident from the above-described possible and also preferred definitions of the radicals Y². The polymers (HP2) to be used are preferably polyurethanes or polyethers having a viscosity of 10 to 30 000 mPas, more preferably of 50 to 15 000 mPas. With particular preference they are polypropylene glycols having a viscosity of 10 to 30 000 mPas.

The viscosity in the context of the present invention is determined after conditioning to 23° C., using a DV 3 rotary viscometer from A. Paar (Brookfield systems), using spindle 5 at 2.5 rpm in accordance with ISO 2555.

The polyols (HP1) and (HP2) used in the invention are commercial products and/or may be prepared by methods which are common in polymer chemistry.

The isocyanate-functional silanes (S) of the general formula (V) are preferably OCN(CH₂)₃—Si(OCH₃)₃, OCN(CH₂)₃—Si(OC₂H₅)₃, OCN(CH₂)₃—Si(OCH₃)₂CH₃, OCN(CH₂)₃—Si(OC₂H₅)₂CH₃, OCN(CH₂)—Si(OCH₃)₃, OCN(CH₂)—Si(OC₂H₅)₃, OCN(CH₂)—Si(OCH₃)₂CH₃ or OCN(CH₂)—Si(OC₂H₅)₂CH₃, with particular preference being given to OCN(CH₂)₃—Si(OCH₃)₃ or OCN(CH₂)—Si(OCH₃)₂CH₃.

The components used in the process of the invention may in each case comprise one kind of such a component or else a mixture of at least two kinds of a respective component.

Both process steps of the invention are carried out preferably in the presence of a catalyst (K). In this context it is possible to use all catalysts used for the catalysis of isocyanates with alcohols. Preferred examples of the catalysts used in the invention are bismuth-containing catalysts such as bismuth carboxylates such as bismuth (2-ethylhexanoate), bismuth neodecanoate or bismuth tetramethylheptanedionate. Catalysts which as well as bismuth also include other metals too, especially mixed bismuth-zinc catalysts, are also suitable for the process of the invention. Further preferred examples are tin-containing catalysts such as dioctyltin dilaurate, dioctyltin oxide, dioctyltin bis(acetylacetonate), dibutyltin dilaurate, dibutyltin oxide, dibutyltin bis(acetylacetonate), zirconium-containing catalysts such as zirconium acetylacetonates, iron-containing catalysts such as iron acetylacetonate, and also the acetylacetonates of other metals.

With particular preference the catalysts (K) used in the invention are carboxylates of bismuth, particular preference being given to bismuth (2-ethylhexanoate), bismuth neodecanoate or mixtures thereof. Examples of commercially available catalysts are Borchi® Kat 22, Borchi® Kat VP 0243, Borchi® Kat VP 0244 or OMG 315 (all OMG-Borchers), Bi neodecanoate from Chemos or American Elements, Reaxis MSA 70 or Reaxis C 719 from Reaxis, BICAT® catalysts (The Shepherd Chemical Company, USA) and K-Kat® K-348 (King Industries, Inc., USA).

In process steps 1 and 2 of the invention, catalysts (K) are used in amounts of preferably 1 to 1000 ppm, more preferably 20 to 600 ppm, more particularly 60 to 400 ppm. The ppm notation here describes one part by weight of catalyst (K) per 1 000 000 parts by weight of reaction mixture. The catalysts (K) are preferably added during the first process step. In the case of a continuous process, the catalyst is added preferably during the mixing step of process step 1. In process step 2 there is preferably no further addition of catalyst, since catalyst added in process step 1 is of course able to catalyze both process steps.

Both process steps of the invention are carried out preferably at temperatures between 20° C. and 180° C., more preferably between 40° C. and 150° C., more particularly between 50° C. and 120° C.

Both process steps of the invention are carried out preferably at a pressure of 100 to 2000 hPa, more preferably at 900 to 1100 hPa.

Both process steps of the invention are carried out preferably in an inert gas atmosphere, more preferably argon or nitrogen.

Besides the process steps 1 and 2 of the invention, the process of the invention may of course also have further process steps, which in principle may also be carried out between process steps 1 and 2. Preferably, however, the process of the invention has no further process steps apart from process steps 1 and 2 of the invention.

The process of the invention has the advantage that it is quick and simple to implement, using readily available raw materials as reactants.

The process of the invention has the advantage that the polymer mixtures (M) obtained are free from toxicological isocyanate-functional silanes (S).

The process of the invention has the advantage that the polymer mixtures (M) obtained have very low levels of monomeric silanes which can influence the mechanical properties of the adhesives, sealants or coating materials producible from this polymer mixture.

Furthermore, the process of the invention possesses the advantage that the silane-crosslinkable polymer mixtures (M) prepared accordingly are comparatively storage-stable and react only very slowly with atmospheric moisture without addition of an additional curing catalyst. This makes it easier not only to store them but also to carry out further processing of the mixtures.

A further advantage of the process of the invention is that the polymer mixtures (M) prepared can be used further directly, in the production of crosslinkable compositions, for example.

The silane-terminated polymer mixtures (M) prepared in the invention can be used wherever silane-terminated polymers have been used to date.

The invention also provides the polymer mixtures (M) preparable by the above process.

They are suitable in particular for producing crosslinkable compositions, especially adhesives and sealants and also coatings. The crosslinkable compositions are curable in particular at room temperature. The production of silane-crosslinking coatings, adhesives and sealants from such polymers has already been much described in the literature, such as in EP1535940A, for example. The moisture-curing formulations based on silane-terminated polymers that are described in these documents, the further ingredients employed in that context, and also the processes described there for producing such formulations are likewise considered part of the disclosure content of this description, as are the applications described therein for the fully formulated coatings, adhesives and sealants.

In the examples described below, all viscosity figures are based on a temperature of 20° C. Unless otherwise indicated, the examples below are carried out under a pressure of the surrounding atmosphere, in other words at about 1000 hPa, and at room temperature, in other words at about 20° C., or at a temperature which comes about when the reactants are combined at room temperature without additional heating or cooling.

### EXAMPLES

### Example 1a: Preparation of a Mixture of Silane-Terminated Polypropylene Glycols

A 1000 ml reaction vessel with stirring, cooling and heating facilities is charged with 400.0 g (22.2 mmol) of a double-sidedly hydroxy-terminated polypropylene glycol having an average molar mass Mₙ of 18 000 g/mol (available commercially under the name Acclaim® 18200 from Covestro AG, Leverkusen (DE)) and this initial charge is dried with stirring at 80° C. and 1 mbar for 2 h. Thereafter the vacuum is broken with nitrogen. The entirety of the subsequent reaction is carried out under an inert gas atmosphere of nitrogen.

To implement the silane termination, the dried polyether is admixed first dropwise at 80° C. with 18.2 g (88.8 mmol) of 3-isocyanatopropyltrimethoxysilane (available commercially under the name GENIOSIL® GF40 from Wacker Chemie AG, Munich (DE)) and then via an Eppendorf pipette with 0.62 g of Borchi catalyst 315 (a catalyst containing bismuth neadecanoate, from Borchers). This corresponds to a value of 150 ppm of catalyst, based on the total weight of the reaction mixture. Directly after the addition of catalyst, the reaction mixture warms up to 82-83° C. This is followed by stirring at a temperature of 80° C.

After 60 min at unaltered temperature, 266.4 g (53.3 mmol) of a monohydroxy-monobutoxy-terminated polypropylene glycol having an average molar mass Mₙ of 5000 g/mol (available commercially under the name Preminol® S 1005 at AGC Chemicals Europe, LTD, Amsterdam (NL)) are added. This is followed by stirring for a further 60 min at 80° C. Thereafter a sample is taken from the reaction mixture and is analyzed by IR analysis for the possible presence of remaining isocyanatosilane residues. The sample is isocyanate-free.

### Example 1b: Preparation of a Mixture of Silane-Terminated Polypropylene Glycols

The procedure is the same as in Example 1a, with the following amendments:
In process step 1 (reaction of the Acclaim® 18200 with the isocyanate-functional silane) a smaller silane excess is used, of only 13.7 g (66.8 mmol).
In process step 2 (reaction of the excess isocyanate-functional silane the monofunctional polypropylene glycol), correspondingly less Preminol® S 1005 is added, at 133.2 g (26.6 mmol).

Here again an isocyanate-free polymer mixture is obtained.

### Comparative Example 1c: Preparation of a Non-Inventive Silane-Terminated Polypropylene Glycol

The procedure is the same as in Example 1a, with the following amendments:
In process step 1 (reaction of the Acclaim® 18200 with the isocyanate-functional silane) an even smaller silane excess is used, of only 10.9 g (53.3 mmol).
In process step 2 no Preminol® S 1005 is added. Instead, the excess isocyanatosilane is destroyed by addition of 0.43 g (13.4 mmol) of methanol. In contrast to Example 1a, the reaction temperature is lowered to 60° C. at the start of process step 2, i.e. directly before addition of the methanol, and after the addition of methanol stirring is continued at this temperature for 60 min.

The polymer obtained is isocyanate-free.

### Example 2a: Production of an Adhesive Formulation

40.0 g of the polymer mixture from Example 1a are mixed in a laboratory planetary mixer from PC-Laborsystem, fitted with a beam mixer and a dissolver, with 20 g of diisononyl phthalate (available commercially from companies including Merck KGaA, Darmstadt (DE)), 4.0 g of vinyltrimethoxysilane (available commercially under the name GENIOSIL® XL 10 from Wacker Chemie AG, Munich (DE)), 1.0 g of a stabilizer mixture (mixture of 20% Irganox® 1135 (CAS No. 125643-61-0), 40% Tinuvin® 571 (CAS No. 23328-53-2) and 40% Tinuvin® 765 (CAS No. 41556-26-7), available commercially under the name TINUVIN® B 75 from BASF SE, Germany), 24.2 g of a calcium carbonate coated with stearic acid and having an average particle diameter (D50%) of around 2.0 □m (available commercially under the name Omyabond 520 from Omya, Cologne (DE)) and 72.6 g of a precipitated calcium carbonate coated with fatty acid and having an average particle diameter (D50%) of around 0.07 □m (available commercially under the name Hakuenka CCR S10 from Shiraishi Omya GmbH, Gummem (AT)), and the solids are stirred in with the beam mixer at 200 rpm for one minute. Stirring continues thereafter for 5 min at 600 rpm with the beam mixer and 1000 rpm with the dissolver.

A further 30 g of diisononyl phthalate, 6.0 g of a hydrophobic pyrogenic silica having a BET surface area of around 200 m²/g (available commercially under the name HDK® H₁₈ from Wacker Chemie AG, Munich (DE)), 0.2 g of dioctyltin dilaurate (available commercially under the name TIB KAT 216 from TIB Chemicals AG, Mannheim (DE)) and 2 g of N-(2-aminoethyl)-3-aminopropyltrimethoxysilane (available commercially under the name GENIOSIL® GF 9 from Wacker Chemie AG, Munich (DE)) are added and are stirred in for one minute at 600 rpm with the beam mixer and at 1000 rpm with the dissolver. This is followed by homogenization and bubble-free stirring under a partial vacuum (around 100 mbar) for 1 minute with the beam mixer at 600 rpm and for 1 minute at 200 rpm.

The composition obtained accordingly is dispensed into 310 ml PE cartridges and stored at 20° C. for 24 hours prior to analysis.

### Example 2b: Production of an Adhesive Formulation

The procedure is as in Example 2a, replacing the polymer mixture from Example 1a with an identical amount of the polymer mixture from Example 1b.

### Comparative Example 2c: Production of an Adhesive Formulation (not Inventive)

The procedure is as in Example 1a, replacing the polymer mixture from Example 1a with an identical amount of the polymer from comparative example 1c.

### Example 3: Determination of Property Profiles of the Adhesive Formulations Produced

The adhesives obtained in Examples 1a to 1c are caused to crosslink and then studied for their skinning, their mechanical properties, and their adhesion to various substrates. The results are found in Table 1.

Skin Time (ST)

To determine the skin time, the crosslinkable compositions obtained in the examples are applied in a layer 2 mm thick to PE film and stored under standard conditions (23° C. and 50% relative atmospheric humidity). In the course of curing, the formation of a skin is tested every 5 min. This is done by placing a dry laboratory spatula carefully on the surface of the sample and pulling it upwards. If sample remains adhering on the finger, a skin has not yet formed. If sample no longer remains adhering on the finger, a skin has formed and the time is recorded.

Mechanical Properties

The compositions are each coated out onto milled Teflon plates with a depth of 2 mm and cured for 2 weeks at 23° C. and 50 relative humidity.

Shore A hardness is determined according to DIN 53505.

Tensile strength is determined according to DIN 53504-S1.

The 100% modulus is determined according to DIN 53504-S1.

Elongation at break is determined according to DIN 53504-S1.

Adhesion Profile without Water Storage

Using the compositions, adhesion tests are conducted in each case on the substrates indicated in Table 1, under the following conditions:

A bead 5-7 cm thick is applied to the substrate, which is stored in a conditioning cabinet at room temperature and a relative humidity of 50% for 14 days.

After storage, a peel test is conducted, in which the bead is cut off from the substrate at one end with a sharp knife to a length of around 2 cm. Subsequently, starting from this cut, the remainder of the bead is pulled from the substrate, and the nature of the resulting fracture (cohesive and/or adhesive) is assessed.

Adhesion Profile with Water Storage

Using the compositions, adhesion tests are conducted in each case on the substrates indicated in Table 1, under the following conditions:

A bead 5-7 cm thick is applied to the substrate, which is stored in a conditioning cabinet at room temperature and a relative humidity of 50% for 14 days. The sample is subsequently stored under water at room temperature for a further 14 days.

The subsequent peel test is again carried out as described above.

TABLE 1

| Composition from Example | 2a | 2b | 2c* (C) |
|---|---|---|---|
| Skin time [min] | 46 | 28 | 32 |
| Shore A hardness | 35 | 45 | 48 |
| Tensile strength [N/mm²] | 2.0 | 2.8 | 2.6 |
| 100% modulus | 0.8 | 1.3 | 1.2 |
| Elongation at break [%] | 360 | 324 | 268 |
| Adhesion without water storage | | | |
| AIMGSi1 | Φ | Φ | Φ |
| AIMg1 | + | + | + |
| AIMg anodized | + | + | + |
| Stainless steel | + | + | + |
| Copper | + | + | + |
| Cut concrete Rocholl | + | + | + |
| Glass | + | + | + |
| Wood (beech) | + | + | + |
| PMMA | − | − | − |
| PMMA filled | + | + | − |
| ABS | − | − | − |
| PVC flexible | + | + | − |
| PVC rigid, Simona transparent | − | − | − |
| PVC rigid grey Simona CAW | − | − | − |
| PVC rigid white Komadur ES | + | − | − |
| Polycarbonate | + | − | − |
| Polystyrene | + | − | − |
| Adhesion with water storage | | | |
| AIMGSi1 | + | + | + |
| AIMg1 | + | + | + |
| AIMg anodized | + | + | + |
| Stainless steel | + | − | − |
| Copper | + | + | + |
| Cut concrete Rocholl | − | − | − |
| Glass | + | + | + |
| Wood (beech) | − | − | − |
| PMMA | − | − | − |
| PMMA filled | + | Φ | − |
| ABS | − | − | − |
| PVC flexible | + | − | − |
| PVC rigid, Simona transparent | + | Φ | − |
| PVC rigid grey Simona CAW | + | − | − |
| PVC rigid white Komadur ES | + | − | − |
| Polycarbonate | − | − | − |
| Polystyrene | + | − | − |

(+) good adhesion/cohesive fracture in peel test
(Ø) partial adhesion/cohesive and adhesive fracture in peel test
(−) no adhesion/adhesive fracture in peel test
*not inventive

### Example 4a: Preparation of a Mixture of Silane-Terminated Polyethers

A 1000 ml reaction vessel with stirring, cooling and heating facilities is charged with 400.0 g (33.3 mmol) of a double-sidedly hydroxy-terminated polypropylene glycol having an average molar mass Mₙ of 12 000 g/mol (available commercially under the name Acclaim® 12200 from Covestro AG, Leverkusen (DE)) and this initial charge is dried with stirring at 80° C. and 1 mbar for 2 h. Thereafter the vacuum is broken with nitrogen. The entirety of the subsequent reaction is carried out under an inert gas atmosphere of nitrogen.

To implement the silane termination, the dried polyether is admixed first dropwise at 80° C. with 12.9 g (80.0 mmol) of isocyanatomethylmethyldimethoxysilane (available commercially under the name GENIOSIL® XL42 from Wacker Chemie AG, Munich (DE)) and then via an Eppendorf pipette with 0.62 g of Borchi catalyst 315. Directly after the addition of catalyst, the reaction mixture warms up to 83-84° C. This is followed by stirring at a temperature of 80° C.

After 60 min at unaltered temperature, 4.1 g (20.0 mmol) of methyltriglycol are added. This is followed by stirring for a further 60 min at 80° C. Thereafter a sample is taken from the reaction mixture and is analyzed by IR analysis for the possible presence of remaining isocyanatosilane residues. The sample is isocyanate-free.

### Example 4b: Preparation of a Mixture of Silane-Terminated Polyethers

The procedure is as in Example 4a, but in the second process step, rather than 4.1 g of methyltriglycol, 7.0 g (20 mmol) of a polyglycol monomethyl ether having an average molecular mass Mₙ of 350 g/mol (available commercially under the name Polyglycol M 350 from Clariant, Basel (CH)) are used.

### Example 5a: Production of an Adhesive Formulation

58.0 g of the polymer mixture from Example 4a are mixed in a laboratory planetary mixer from PC-Laborsystem, fitted with a beam mixer and a dissolver, with 40 g of diisoundecyl phthalate (available commercially under the name Jayfiex DIUP from ExxonMobil), 4.0 g of vinyltrimethoxysilane and 96.0 g of a ground calcium carbonate coated with stearic acid and having an average particle diameter (D50%) of around 0.4 □m (available commercially under the name Omyabond 302 from Omya, Cologne (DE)), and the calcium carbonate is stirred in with the beam mixer at 200 rpm for one minute. Stirring continues thereafter for 5 min at 600 rpm with the beam mixer and 1000 rpm with the dissolver.

2 g of 3-aminopropyltrimethoxysilane (available commercially under the name GENIOSIL® GF 96 from Wacker Chemie AG, Munich (DE)) are added and are stirred in for one minute at 600 rpm with the beam mixer and at 1000 rpm with the dissolver. This is followed by homogenization and bubble-free stirring under a partial vacuum (around 100 mbar) for 1 minute with the beam mixer at 600 rpm and for 1 minute at 200 rpm.

The composition obtained accordingly is dispensed into 310 ml PE cartridges and stored at 20° C. for 24 hours prior to analysis.

### Example 5b: Production of a Sealant Formulation

The procedure is as in Example 5a, replacing the polymer mixture from Example 4a with an identical amount of the polymer mixture from Example 4b.

### Example 6: Determination of Property Profiles of the Sealant Formulations Produced

The adhesives obtained in Examples 5a and 5b are caused to crosslink and are studied by the methods described in Example 3 in terms of their skinning and their mechanical properties. The results are found in Table 2.

TABLE 2

| Composition from Example | 5a | 5b |
|---|---|---|
| Skin time [min] | 18 | 18 |
| Shore A hardness | 47 | 49 |
| Tensile strength [N/mm²] | 2.4 | 2.4 |
| 100% modulus | 1.4 | 1.5 |
| Elongation at break [%] | 206 | 187 |

### Example 7: Preparation of a Mixture of Silane-Terminated Polyethers

A 1000 ml reaction vessel with stirring, cooling and heating facilities is charged with 400.0 g (22.2 mmol) of a double-sidedly hydroxy-terminated polypropylene glycol having an average molar mass Mₙ of 18 000 g/mol (available commercially under the name Acclaim® 18200 from Covestro AG, Leverkusen (DE)) and this initial charge is dried with stirring at 80° C. and 1 mbar for 2 h. Thereafter the vacuum is broken with nitrogen. The entirety of the subsequent reaction is carried out under an inert gas atmosphere of nitrogen.

To implement the silane termination, the dried polyether is admixed first dropwise at 80° C. with 10.9 g (53.3 mmol) of 3-isocyanatopropyltrimethoxysilane and then via an Eppendorf pipette with 0.62 g of Borchi catalyst 315. Directly after the addition of catalyst, the reaction mixture warms up to 82-83° C. This is followed by stirring at a temperature of 80° C.

After 60 min at unaltered temperature, 4.7 g (13.4 mmol) of a polyglycol monomethyl ether having an average molecular mass Mₙ of 350 g/mol (available commercially under the name Polyglycol M 350 from Clariant, Basel (CH)) are added. This is followed by stirring for a further 60 min at 80° C. Thereafter a sample is taken from the reaction mixture and is analyzed by IR analysis for the possible presence of remaining isocyanatosilane residues. The sample is isocyanate-free.

### Example 8: Production of an Adhesive Formulation and Determination of its Properties

58.0 g of the polymer mixture from Example 4a are mixed in a laboratory planetary mixer from PC-Laborsystem, fitted with a beam mixer and a dissolver, with 40 g of diisoundecyl phthalate (available commercially under the name Jayfiex DIUP from ExxonMobil), 4.0 g of vinyltrimethoxysilane and 95.6 g of a ground calcium carbonate coated with stearic acid and having an average particle diameter (D50%) of around 0.4 □m (available commercially under the name Omyabond 302 from Omya, Cologne (DE)), and the calcium carbonate is stirred in with the beam mixer at 200 rpm for one minute. Stirring continues thereafter for 5 min at 600 rpm with the beam mixer and 1000 rpm with the dissolver.

2 g of 3-aminopropyltrimethoxysilane and 0.4 g of dioctyltin dilaurate are added and are stirred in for one minute at 600 rpm with the beam mixer and at 1000 rpm with the dissolver. This is followed by homogenization and bubble-free stirring under a partial vacuum (around 100 mbar) for 1 minute with the beam mixer at 600 rpm and for 1 minute at 200 rpm.

The composition obtained accordingly is dispensed into 310 ml PE cartridges and stored at 20° C. for 24 hours prior to analysis.

The resulting adhesives are caused to crosslink and investigated by the methods described in Example 3 in terms of its skinning and its mechanical properties. The skin time is 17 min, the Shore A hardness 49, tensile strength 2.6 N/mm², the 100% modulus 1.23 N/mm² and the elongation at break 209%.

### Example 9a: Preparation of a Mixture of Silane-Terminated Polyethers

A 1000 ml reaction vessel with stirring, cooling and heating facilities is charged with 400.0 g (33.3 mmol) of a double-sidedly hydroxy-terminated polypropylene glycol having an average molar mass Mₙ of 12 000 g/mol (available commercially under the name Acclaim® 12200 from Covestro AG, Leverkusen (DE)) and this initial charge is dried with stirring at 80° C. and 1 mbar for 2 h. Thereafter the vacuum is broken with nitrogen. The entirety of the subsequent reaction is carried out under an inert gas atmosphere of nitrogen.

To implement the silane termination, the dried polyether is admixed first dropwise at 80° C. with 21.5 g (133.2 mmol) of isocyanatomethylmethyldimethoxysilane and then via an Eppendorf pipette with 0.62 g of Borchi catalyst 315. Directly after the addition of catalyst, the reaction mixture warms up to around 84° C. This is followed by stirring at a temperature of 80° C.

After 60 min at unaltered temperature, 12.0 g (40.0 mmol) of a hydroxy-terminated at both ends and having an average molar mass Mₙ of 300 g/mol (available commercially under the name Polyglycol 300 from Clariant, Basel (CH)) are added. This is followed by stirring for a further 60 min at 80° C. Thereafter a sample is taken from the reaction mixture and is analyzed by IR analysis for the possible presence of remaining isocyanatosilane residues. The sample is isocyanate-free.

### Example 9b: Preparation of a Mixture of Silane-Terminated Polyethers

The procedure is the same as in Example 9a, with the following amendments:
In process step 1 (reaction of the Acclaim® 12200 with the isocyanate-functional silane) a smaller silane excess is used, of only 16.1 g (99.9 mmol).
In process step 2 (reaction of the excess isocyanate-functional silane the difunctional ethylene glycol), correspondingly less Polyglycol 300 is added, at 7.5 g (25.0 mmol).

Here again an isocyanate-free polymer mixture is obtained.

### Comparative Example 9c: Preparation of a Non-Inventive Silane-Terminated Polypropylene Glycol

The procedure is the same as in Example 9a, with the following amendments:
In process step 1 (reaction of the Acclaim® 12200 with the isocyanate-functional silane) an even smaller silane excess is used, of only 12.9 g (79.9 mmol).
In process step 2 no Polyglycol 300 is added. Instead, the excess isocyanatosilane is destroyed by addition of 0.64 g (20.0 mmol) of methanol. In contrast to Example 9a, the reaction temperature is lowered to 60° C. at the start of process step 2, i.e. directly before addition of the methanol, and after the addition of methanol stirring is continued at this temperature for 60 min.

The polymer obtained is isocyanate-free.

### Example 10a: Production of an Adhesive Formulation

58.0 g of the polymer mixture from Example 4a are mixed in a laboratory planetary mixer from PC-Laborsystem, fitted with a beam mixer and a dissolver, with 40 g of diisoundecyl phthalate (available commercially under the name Jayflex DIUP from ExxonMobil), 4.0 g of vinyltrimethoxysilane and 96.0 g of a ground calcium carbonate coated with stearic acid and having an average particle diameter (D50%) of around 0.4 □m (available commercially under the name Omyabond 302 from Omya, Cologne (DE)) and the calcium carbonate is stirred in with the beam mixer at 200 rpm for one minute. Stirring continues thereafter for 5 min at 600 rpm with the beam mixer and 1000 rpm with the dissolver.

2 g of 3-aminopropyltrimethoxysilane are added and stirred in for one minute at 600 rpm with the beam mixer and at 1000 rpm with the dissolver. This is followed by homogenization and bubble-free stirring under a partial vacuum (around 100 mbar) for 1 minute with the beam mixer at 600 rpm and for 1 minute at 200 rpm.

The composition obtained accordingly is dispensed into 310 ml PE cartridges and stored at 20° C. for 24 hours prior to analysis.

### Example 10b: Production of an Adhesive Formulation

The procedure is as in Example 10a, replacing the polymer mixture from Example 9a with an identical amount of the polymer mixture from Example 9b.

### Comparative Example 10c: Production of an Adhesive Formulation

The procedure is as in Example 9a, replacing the polymer mixture from Example 9a with an identical amount of the polymer from comparative example 9c.

### Example 11: Determination of Property Profiles of the Adhesive Formulations Produced

The adhesives obtained in Examples 10a to 10c are caused to crosslink and studied by the methods described in Example 3 in terms of their skinning and their mechanical properties. The results are found in Table 3.

TABLE 3

| Composition from Example | 10a | 10b | 10c* (C) |
|---|---|---|---|
| Skin time [min] | 21 | 22 | 25 |
| Shore A hardness | 45 | 47 | 48 |
| Tensile strength [N/mm²] | 1.9 | 2.2 | 2.0 |
| 100% modulus | 1.2 | 1.3 | 1.51 |
| Elongation at break [%] | 170 | 180 | 150 |

*not inventive

### Example 12: Preparation of a Mixture of Silane-Terminated Polyethers

A 1000 ml reaction vessel with stirring, cooling and heating facilities is charged with 400.0 g (33.3 mmol) of a double-sidedly hydroxy-terminated polypropylene glycol having an average molar mass Mₙ of 12 000 g/mol (available commercially under the name Acclaim® 12200 from Covestro AG, Leverkusen (DE)) and this initial charge is dried with stirring at 80° C. and 1 mbar for 2 h. Thereafter the vacuum is broken with nitrogen. The entirety of the subsequent reaction is carried out under an inert gas atmosphere of nitrogen.

To implement the silane termination, the dried polyether is admixed first dropwise at 80° C. with 12.9 g (80.0 mmol) of isocyanatomethylmethyldimethoxysilane and then via an Eppendorf pipette with 0.62 g of Borchi catalyst 315. Directly after the addition of catalyst, the reaction mixture warms up to 83-84° C. This is followed by stirring at a temperature of 80° C.

After 60 min at unaltered temperature, 4.0 g (20.0 mmol) of a hydroxy-terminated at both ends and having an average molar mass Mₙ of 200 g/mol are added. This is followed by stirring for a further 60 min at 80° C. Thereafter a sample is taken from the reaction mixture and is analyzed by IR analysis for the possible presence of remaining isocyanatosilane residues. The sample is isocyanate-free.

### Example 13: Production of an Adhesive Formulation and Determination of its Properties

58.0 g of the polymer mixture from Example 12 are mixed in a laboratory planetary mixer from PC-Laborsystem, fitted with a beam mixer and a dissolver, with 40 g of diisoundecyl phthalate (available commercially under the name Jayflex DIUP from ExxonMobil), 4.0 g of vinyltrimethoxysilane and 96.0 g of a ground calcium carbonate coated with stearic acid and having an average particle diameter (D50%) of around 0.4 □m (available commercially under the name Omyabond 302 from Omya, Cologne (DE)), and the calcium carbonate is stirred in with the beam mixer at 200 rpm for one minute. Stirring continues thereafter for 5 min at 600 rpm with the beam mixer and 1000 rpm with the dissolver.

2 g of 3-aminopropyltrimethoxysilane are added and are stirred in for one minute at 600 rpm with the beam mixer and at 1000 rpm with the dissolver. This is followed by homogenization and bubble-free stirring under a partial vacuum (around 100 mbar) for 1 minute with the beam mixer at 600 rpm and for 1 minute at 200 rpm.

The composition obtained accordingly is dispensed into 310 ml PE cartridges and stored at 20° C. for 24 hours prior to analysis.

The resulting adhesives are caused to crosslink and investigated by the methods described in Example 3 in terms of its skinning and its mechanical properties. The skin time is 14 min, the Shore A hardness 44, tensile strength 2.1 N/mm², the 100% modulus 1.34 N/mm² and the elongation at break 170%.

### Example 14: Preparation of a Mixture of Silane-Terminated Polyethers

A 1000 ml reaction vessel with stirring, cooling and heating facilities is charged with 400.0 g (22.2 mmol) of a double-sidedly hydroxy-terminated polypropylene glycol having an average molar mass Mₙ of 18 000 g/mol (available commercially under the name Acclaim® 18200 from Covestro AG, Leverkusen (DE)) and this initial charge is dried with stirring at 80° C. and 1 mbar for 2 h. Thereafter the vacuum is broken with nitrogen. The entirety of the subsequent reaction is carried out under an inert gas atmosphere of nitrogen.

To implement the silane termination, the dried polyether is admixed first dropwise at 80° C. with 8.6 g (53.3 mmol) of 3-isocyanatomethylmethyldimethoxysilane and then via an Eppendorf pipette with 0.62 g of Borchi catalyst 315. Directly after the addition of catalyst, the reaction mixture warms up to 82-83° C. This is followed by stirring at a temperature of 80° C.

After 60 min at unaltered temperature, 1.3 g (6.5 mmol) of a hydroxy-terminated at both ends and having an average molar mass Mₙ of 200 g/mol (available commercially under the name Polyglycol 300 from Clariant, Basel (CH)) are added. This is followed by stirring for a further 60 min at 80° C. Thereafter a sample is taken from the reaction mixture and is analyzed by IR analysis for the possible presence of remaining isocyanatosilane residues. The sample is isocyanate-free.

### Example 15: Production of an Adhesive Formulation and Determination of its Properties

58.0 g of the polymer mixture from Example 14 are mixed in a laboratory planetary mixer from PC-Laborsystem, fitted with a beam mixer and a dissolver, with 40 g of diisoundecyl phthalate (available commercially under the name Jayflex DIUP from ExxonMobil), 4.0 g of vinyltrimethoxysilane and 96 g of a ground calcium carbonate coated with stearic acid and having an average particle diameter (D50%) of around 0.4 □m (available commercially under the name Omyabond 302 from Omya, Cologne (DE)), and the calcium carbonate is stirred in with the beam mixer at 200 rpm for one minute. Stirring continues thereafter for 5 min at 600 rpm with the beam mixer and 1000 rpm with the dissolver.

2 g of 3-aminopropyltrimethoxysilane are added and are stirred in for one minute at 600 rpm with the beam mixer and at 1000 rpm with the dissolver. This is followed by homogenization and bubble-free stirring under a partial vacuum (around 100 mbar) for 1 minute with the beam mixer at 600 rpm and for 1 minute at 200 rpm.

The composition obtained accordingly is dispensed into 310 ml PE cartridges and stored at 20° C. for 24 hours prior to analysis.

The resulting adhesives are caused to crosslink and investigated by the methods described in Example 3 in terms of its skinning and its mechanical properties. The skin time is 20 min, the Shore A hardness 40, tensile strength 2.5 N/mm², the 100% modulus 0.82 N/mm² and the elongation at break 317%.

1-12. (canceled)

13. A process for preparing a mixture (M), comprising:
providing silane-terminated polymers (SP1) of the general formula (I)
Y¹—[O—C(═O)—NH—(CR¹₂)_{b}—SiRₐ(OR²)₃₋ₐ]ₓ (I),
optionally silane-terminated polymers (SP2) of the general formula (II)
Y²—[O—C(═O)—NH—(CR¹₂)_{b}—SiRₐ(OR²)₃₋ₐ]_{z} (II)
and hydroxy-functional polymers (SP3) of the general formula (III)
Y²—[O—C(═O)—NH—(CR¹₂)_{b}—SiRₐ(OR²)₃₋ₐ]_{z-z1}(OH)_{z1} (III)
wherein Y¹ is an x-valent polymer radical having a numerical average molar mass Mₙ of at least 2000 g/mol;
wherein Y² is a z-valent oligomer or polymer radical having at least 3 identical repeating units which contain at least 2 carbon atoms and at least 1 heteroatom;
wherein R may be identical or different and is a monovalent, optionally substituted hydrocarbon radical;
wherein R¹ may be identical or different and is hydrogen atom or a monovalent, optionally substituted hydrocarbon radical;
wherein R² may be identical or different and is hydrogen atom or a monovalent, optionally substituted hydrocarbon radical;
wherein x is an integer from 2 to 50;
wherein z is an integer from 1 to 50;
wherein z1 is less than or equal to z and is an integer from 1 to 50,
wherein a may be identical or different and is 0, 1 or 2; and
wherein b may be identical or different and is an integer from 1 to 10;
wherein, in a first process step, at least one polymer (HP1) of the general formula (IV)
Y¹—[OH]ₓ (IV)
reacts with at least one isocyanate-functional silane (S) of the general formula (V)
O═C═N—(CR¹₂)_{b}—SiRₐ(OR²)₃₋ₐ (V)
to give silane-terminated polymers (SP1);
wherein the isocyanate-functional silane (S) of the general formula (V) is used in an amount such that there are at least 1.1 isocyanate groups of the isocyanate-functional silane (S) of the general formula (V) to each hydroxyl group in the compounds (HP1) of the general formula (IV);
wherein in a subsequent second process step, all unreacted isocyanate groups of the isocyanate-functional silane (S) of the general formula (V) are reacted with at least one oligomer or polymer (HP2) of the general formula (VI)
Y²(OH)_{z} (VI),
and the compound (HP2) of the general formula (VI) is used in an amount such that there are at least 1.1 hydroxyl groups in the compounds (HP2) of the general formula (IV) to each isocyanate group still present in the reaction mixture after the first process step; and
wherein either z and z1 in the general formulae (II), (III) and (VI) possess a value of 1, there are silane-terminated polymers (SP2) of the general formula (II) in the mixture (M), and the polymers (SP3) likewise present in the mixture (M) correspond to the polymers (HP2) used in the second reaction step, or z in the general formulae (II), (III) and (VI) possesses a value of more than 1, Y² is a z-valent oligomer or polymer radical having a numerical average molar mass Mₙ of at most 1500 g/mol, and the mixture (M) comprises hydroxy-functional polymers (SP3) in which z1 is less than z.

14. The process of claim 13, wherein z possesses a value of at least 2 and wherein Y² is a z-valent oligomer or polymer radical having a numerical average molar mass Mₙ of at most 1000 g/mol.

15. The process of claim 13, wherein x is a value of 2 or 3.

16. The process of claim 13, wherein z is a value of 1 or 2.

17. The process of claim 13, wherein z1 is a value of 1 or 2.

18. The process of claim 13, wherein b is a value of 1 or 3.

19. The process of claim 13, wherein R is a monovalent hydrocarbon radical having 1 to 6 carbon atoms.

20. The process of claim 13, wherein the polymer radical Y¹ is selected from polyester, polyether, polyurethane, polyalkylene or polyacrylate radicals.

21. The process of claim 13, wherein the polymer radical Y² is selected from polyester, polyether, polyurethane, polyalkylene or polyacrylate radicals.

22. The process of claim 13, wherein the first and second process steps are carried out in the presence of a bismuth-containing catalyst (K).

23. The process of claim 13, wherein the mixture produced by the mixture (M) is a polymer mixture.

24. The process of claim 23, wherein the polymer mixture is used as an adhesive, a sealant or a coating.
